(19) United States
(12) Patent Application Publication
(10) Pub. No.: US 2025/0197773 A1
(43) Pub. Date: Jun. 19, 2025

(54) SELF PRESERVED MILD LIQUID DETERGENT

(71) Applicant: Henkel AG & Co. KGaA, Duesseldorf (DE)

(72) Inventor: Daniel Thomas PIORKOWSKI, Fairfield, CT (US)

(73) Assignee: Henkel AG & Co. KGaA, Duesseldorf (DE)

(21) Appl. No.: 18/955,408

(22) Filed: Nov. 21, 2024

Related U.S. Application Data
(60) Provisional application No. 63/612,096, filed on Dec. 19, 2023.

(51) Int. Cl. C11D 3/20; C11D 1/29; C11D 1/72; C11D 3/00; C11D 3/386

(52) U.S. Cl. CPC C11D 3/2065; C11D 1/29; C11D 1/72; C11D 3/0047; C11D 3/38618; C11D 2111/12

(57) ABSTRACT

The present disclosure provides a detergent composition comprising about 20 to about 35 wt % water, about 20 to about 40 wt % of at least one surfactant, about 25 to about 45 wt % of a non-aqueous solvent comprising glycerin, and at least one enzyme, wherein the water activity is less than 0.8, and the detergent composition has a pH of about 5 to 7.7. The detergent composition can further comprise additional components, such as a base, a performance polymer, an anti-redeposition agent, a chelating agent, an optical brightener, a corrosion inhibitor, or any combination thereof. The detergent composition comprises surfactants with improved mildness and solvents with reduced allergic components.

### BACKGROUND

Laundry detergent compositions contain surfactants which impart good cleaning performance. However, many surfactant compositions can cause skin and eye irritation. Preferred surfactants for efficacy have included the anionic linear alkylbenzene sulfonates (LAS) that can be a harsh additive to detergent compositions, and replacements such as alcohol ethoxysulfonates can contain traces of regulated compounds. Further, solvents included in detergent compositions can be allergens. Propylene glycol was named the 2018 allergen of the year by the American Contact Dermatitis Society.

Water-based products, like liquid laundry detergents, are prone to growing mold and bacteria. To avoid this and keep products safe and effective, liquid detergents need to have added preservatives. However, these preservatives can cause irritation, itching, and redness, particularly in people with sensitive skin.

There is a need for a self-preserved liquid laundry detergent product that can effectively clean textiles while retaining mildness and limiting allergenic compounds.

### BRIEF SUMMARY

The present disclosure relates to a detergent composition comprising about 20 to about 35 wt % water, about 20 to about 40 wt % of at least one surfactant, and about 25 to about 45 wt % of a non-aqueous solvent comprising glycerin, and at least one enzyme; wherein the water activity is less than 0.8, and the detergent composition has a pH of about 5 to about 7.7.

In some aspects, the water activity is between 0.65 to about 0.75.

In some aspects, the detergent composition does not comprise a preservative.

In some aspects, the detergent composition has a Zein score of not more than about 2% or not more than about 1% dissolved zein when tested on a 3% dilution.

In some aspects, the detergent composition comprises about 25 to about 40 wt % of glycerin.

In some aspects, the detergent composition does not comprise propylene glycol. In some aspects, the detergent composition does not comprise polyethylene glycol (PEG).

In some aspects, the at least one surfactant comprises a non-ionic alcohol ethoxylate (AE), an alkyl ether sulfate (AES), or a combination of both. In some aspects, the non-ionic alcohol ethoxylate (AE) comprises the formula R¹-(EO)ₙ—OH, wherein R¹ is a C₁₂-C₁₈ alkyl group, EO is ethoxylate, and n is an integer of moles from 1 to 15.

In some aspects, the detergent composition does not comprise a linear alkylbenzene sulfonate.

In some aspects, the detergent composition further comprises at least one additive selected from an acid, a base, an anti-redeposition agent, a performance polymer, a defoamer, a chelating agent, a chlorine scavenger, an optical brightener, a corrosion inhibitor, and any combination thereof.

In some aspects, the at least one enzyme is selected from a protease, an amylase, a mannanase, a lactase, a lipase, a perhydrolase, an oxidoreductase, an endocellulase, an exocellulase, and any combination thereof. In some aspects, the enzyme is selected from an amylase, a protease, a mannanase, and any combination thereof. In some aspects, the detergent composition comprises about 0.1 to about 5 wt % enzyme.

In some aspects, the detergent composition comprises an acid and a base to form a buffer. In some aspects, the acid is citric acid and the base is NaOH.

In some aspects, the detergent composition has a pH of about 6 to about 7.

In some aspects, the performance polymer comprises at least one of polyethyleneimine ethoxylate and polyethyleneimine ethoxylate propoxylate.

In some aspects, the detergent composition is about 0.4 to about 0.8 fluid ounces per dose.

In some aspects, the detergent composition comprises about 20 to about 35 wt % water, about 25 to about 38 wt % of surfactant comprising a non-ionic alcohol ethoxylate (AE) and an alkyl ether sulfate (AES), about 25 to about 40 wt % of glycerin, about 1 to about 3 wt % of at least one enzyme, an acid, a base, at least one performance polymer, a defoamer, and a chelating agent; wherein the water activity is less than 0.75, and the detergent composition has a pH of about 6 to about 7.

### DETAILED DESCRIPTION

Provided herein is a detergent composition comprising about 20 to about 35 wt % water, about 20 to about 40 wt % of at least one surfactant, and about 25 to about 45 wt % of a non-aqueous solvent comprising glycerin, and at least one enzyme. The water activity is less than 0.8, and the detergent composition has a pH of about 5 to about 7.7.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant FIGURES).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “Zein score” or “Zein number” as used in the present application refers to a score or number measured using a Zein test (see, e.g., Gott, E., Aesthet. Medzin, Tenside 15:313 (1966)), as described in the examples. A Zein test determines the extent of denaturation of Zein corn protein after exposure to a surfactant for a given period of time. Generally, the higher the Zein score, the greater the skin irritation potential.

In some aspects, the detergent compositions described herein have a Zein score of less than about 2% dissolved zein when tested at a 3% dilution. In other aspects the detergent compositions described herein have a Zein score of less than 1% dissolved zein when tested at a 3% dilution. The protocol can also be run on a detergent composition tested at a 10% dilution. In other aspects, the detergent compositions described herein at a 3% dilution (or a 10% dilution) have a Zein score of from about 0.01% to about 2%, from about 0.01% to about 1.75%, about 0.01% to about 1.5%, or about 0.01% to about 1.25%, or about 0.01% to about 1% dissolved zein.

The term “water activity” as used in the present application is often referred to as the “free” or “available water” in a system and is a measure of how efficiently the water present in a system can take part in a reaction or in a physical process. Water activity (aw) is a dimensionless parameter defined as the vapor pressure of water in a system (p) divided by that of pure water at the same temperature (po). It correlates with the proportion of water available for biological or chemical reactions and is related to the energy status of the water molecules in a given system. Pure distilled water has a water activity of 1. For example, a water activity of 0.80 means the vapor pressure is 80% of that of pure water.

### Detergent Composition

In some aspects, the present disclosure is directed to a detergent composition comprising about 20 to about 35 wt % water, about 20 to about 40 wt % of at least one surfactant, and about 25 to about 45 wt % of a non-aqueous solvent comprising glycerin, and at least one enzyme; wherein the water activity is less than 0.8, and the detergent composition has a pH of about 5 to about 7.7.

In some aspects, the detergent composition comprises from about 20 wt % to about 35 wt % of water relative to the total weight of the detergent composition. For example, the water content can be present in an amount from about 20 wt % to about 34 wt %, about 20 wt % to about 33 wt %, about 20 wt % to about 32 wt %, about 20 wt % to about 31 wt %, about 20 wt % to about 30 wt %, about 20 wt % to about 29 wt %, about 20 wt % to about 28 wt %, about 20 wt % to about 27 wt %, about 20 wt % to about 26 wt %, about 20 wt % to about 25 wt %, about 20 wt % to about 24 wt %, about 20 wt % to about 23 wt %, about 20 wt % to about 22 wt %, 20 wt % to about 21 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, or about 20 wt % of the total weight of the detergent composition. In some aspects, the detergent composition comprises from about 21 wt % to about 33 wt % of water relative to the total weight of the detergent composition.

In some aspects, preservation of the detergent composition is controlled by water activity and the use of solvents. Water activity is a measure of the freely available water in a material and indicates the availability of the water for chemical, biochemical, and microbial reactions and processes. Water activity is stated as an aw value and is defined as the quotient of the concentration of water in the vapor phase in the airspace over the material and the water concentration in the airspace over pure water at a specific temperature:

$${a}_{w} = {{\to }^{p}}_{{p}_{0}} .$$

In general, the water activity can be lowered by increasing the amount of non-aqueous solvent (e.g., glycerin) relative to the amount of water. In some aspects, the detergent composition has a water activity less than 0.8. For example, the water activity can be 0.79 or below, 0.78 or below, 0.77 or below, 0.76 or below, 0.75 or below, 0.74 or below, 0.73 or below, 0.72 or below, 0.71 or below, 0.7 or below, 0.69 or below, 0.68 or below, 0.67 or below, 0.66 or below, 0.65 or below, 0.64 or below, 0.63 or below, 0.62 or below, 0.61 or below, 0.6 or below, 0.59 or below, 0.58 or below, 0.57 or below, 0.56 or below, 0.55 or below, 0.54 or below, 0.53 or below, 0.52 or below, 0.51 or below, 0.5 or below, 0.49 or below, 0.48 or below, 0.47 or below, 0.46 or below, 0.45, 0.46. 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, or 0.8. In some aspects the detergent composition has a water activity 0.8 or below (e.g., about 0.5 to about 0.8 or about 0.6 to about 0.8). In some aspects the detergent composition has a water activity of 0.75 or below (e.g., about 0.5 to about 0.75 or about 0.6 to about 0.75).

In some aspects, the water activity is between about 0.45 to about 0.8, between about 0.45 to about 0.75, between about 0.45 to about 0.7, between about 0.45 to about 0.65, between about 0.5 to about 0.8, between about 0.5 to about 0.75, between about 0.5 to about 0.7, between about 0.5 to about 0.65, between about 0.55 to about 0.8, between about 0.55 to about 0.75, between about 0.55 to about 0.7, between about 0.55 to about 0.65, between about 0.6 to about 0.8, between about 0.6 to about 0.75, between about 0.6 to about 0.7, between about 0.6 to about 0.65, between about 0.65 to about 0.8, between about 0.65 to about 0.75, between about 0.65 to about 0.7, or a value or range between any two preceeding values. In some aspects, the water activity is between about 0.65 to about 0.75.

The detergent composition can have any suitable density. In some aspects, the detergent composition has a density greater than the density of water at room temperature (i.e., about 20° C.). In some aspects, the detergent composition has a density (e.g., an approximate density) greater than 1 g/ml to about 2 g/ml (e.g., about 1.05 to about 2 g/ml, about 1.05 to about 1.9 g/ml, about 1.05 to about 1.8 g/ml, about 1.05 to about 2 g/ml, about 1.05 to about 1.7 g/ml, about 1.05 to about 1.6 g/ml, about 1.05 to about 1.5 g/ml, about 1.05 to about 1.4 g/ml, about 1.05 to about 1.3 g/ml, about 1.05 to about 1.2 g/ml, about 1.1 to about 2 g/ml, about 1.1 to about 1.9 g/ml, about 1.1 to about 1.8 g/ml, about 1.1 to about 2 g/ml, about 1.1 to about 1.7 g/ml, about 1.1 to about 1.6 g/ml, about 1.1 to about 1.5 g/ml, about 1.1 to about 1.4 g/ml, about 1.1 to about 1.3 g/ml, about 1.1 to about 1.2 g/ml, about 1.05 g/ml, about 1.1 g/ml, about 1.2 g/ml, about 1.3 g/ml, about 1.4 g/ml, about 1.5 g/ml, about 1.6 g/ml, about 1.7 g/ml, about 1.8 g/ml, about 1.9 g/ml, or about 2 g/ml, at room temperature (i.e., about 20° C.).

The detergent composition can have any suitable viscosity. In some aspects, the detergent composition has a viscosity about 100 to 600 times greater than the viscosity of water at room temperature (i.e., about 20° C.). In some aspects, the detergent composition has a viscosity of about 100 to about 600 cP (e.g., about 100 to about 500 cP, about 100 to about 400 cP, about 100 to about 300 cP, about 100 to about 200 cP, about 200 to about 600 cP, about 200 to about 500 cP, about 200 to about 400 cP, about 200 to about 300 cP, about 300 to about 600 cP, about 300 to about 500 cP, about 300 to about 400 cP, about 300 to about 350 cP, about 400 to about 600 cP, about 200 to about 400 cP, about 500 to about 600 cP, about 100 cP, about 150 cP, about 200 cP, about 250 cP, about 300 cP, about 350 cP, about 400 cP, about 450 cP, about 500 cP, about 550 cP, or about 600 cP, at room temperature (i.e., about 20° C.). In some aspects, the detergent composition has a viscosity of about 350 cP.

In some aspects, the detergent composition does not comprise a preservative (e.g., an added preservative) or biocide, which is any suitable compound with antimicrobial (e.g., antibacterial, antiviral, antifungal) activity. Examples of a biocide that are not contained in the detergent composition include, e.g., dichloroisocyanuric acid, hydrogen peroxide, a quaternary ammonium compound, glutaraldehyde, tetrakis(hydroxymethyl)phosphonium sulfate (THPS), 2,2-dibromo-3-nitrilopropionamide (DBNPA), 2,2-dibromo-3-nitrilipropionamide, 2-(hydroxymethylamino)-ethanol, 2-bromo-2-nitropropane-1,3-diol, β-bromo-β-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorothalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, and any combination thereof.

In some aspects, the detergent composition can have a pH of about 5 to about 7.7 (e.g., about 5.5 to about 7.7, about 6 to about 7.7, about 6.5 to about 7.7, about 7 to about 7.7, about 7.5 to about 7.7, about 5 to about 7.6, about 5.5 to about 7.5, about 5.5 to about 7.3, about 5.5 to about 7.2, about 5.5 to about 7, about 5.5 to about 6.8, about 5.5 to about 6.5, about 5.5 to about 6.3, about 5.5 to about 6, about 6 to about 7.6, about 6 to about 7.5, about 6 to about 7.4, about 6 to about 7.3, about 6 to about 7.1, about 6 to about 7.1, about 6 to about 7, about 6.5 to about 7.6, about 6.5 to about 7.5, about 6.5 to about 7.4, about 6.5 to about 7.3, about 6.5 to about 7.1, about 6.5 to about 7.1, or about 6.5 to about 7). In some aspects, the detergent composition has a pH of about 5.1, about 5.2, about 5.3, about 5.4, about 5.5, about 5.6, about 5.7, about 5.8, about 5.9, about 6, about 6.1, about 6.2, about 6.3, about 6.4, about 6.5, about 6.6, about 6.7, about 6.8, about 6.9, about 7, about 7.1, about 7.2, about 7.3, about 7.4, about 7.5, about 7.6, or about 7.7. In some aspects, the detergent composition has a pH of about 6 to about 7.1. In some aspects, the detergent composition has a pH of about 6 to about 7. In some aspects, the detergent composition has a pH of about 7.

It was discovered that a mild composition (i.e., a composition with a low Zein score) could be provided with a detergent composition comprising mild surfactants. In some aspects, the detergent composition has a Zein score that is not more than 2% dissolved zein when tested on a 3% dilution (or 10% dilution) of the detergent composition when measured in accordance with the method set forth herein and in Gott (Aesthet. Medzin. Tenside 15:313 (1966)), the disclosure of which is incorporated herein by reference in its entirety. In some aspects, the detergent composition has a Zein score of not more than 1% dissolved zein when tested on a 3% dilution (or 10% dilution). In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 3% dilution (or 10% dilution).

In an aspect, the detergent composition comprises at least one non-aqueous solvent in addition to glycerin. In some aspects, the non-aqueous comprises an alcohol (e.g., a C₁₋₄ alcohol), a polyol (e.g., a diol, a triol, or higher, such as polyethylene glycol), or any combination thereof. Suitable examples of a solvent include, e.g., ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, polyethylene glycol, ethanol, or any combination thereof.

In some aspects, the non-aqueous solvent further comprises polyethylene glycol (PEG), which can have the structure:

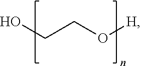

wherein n is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/mol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, about 600 g/mol, about 800 g/mol, or about 1000 g/mol). In some aspects, the non-aqueous solvent comprises polyethylene glycol with a molecular weight of about 200 to about 1000 g/mol or about 400 g/mol. In some aspects, the PEG comprises PEG 400, which has a number average molecular weight of about 380 to about 420 g/mol.

In some aspects, the non-aqueous solvent comprises at least glycerin. In some aspects, the non-aqueous solvent further comprises ethanol. In some aspects, the non-aqueous solvent comprises PEG, glycerin, and ethanol.

In some aspects the detergent composition does not comprise propylene glycol. In some aspects, the detergent composition does not comprise polyethylene glycol (PEG). In some aspects the detergent composition does not comprise propylene glycol or PEG.

In some aspects, the detergent composition comprises from about 25 wt % to about 45 wt % of a non-aqueous solvent comprising glycerin relative to the total weight of the detergent composition. For example, the total non-aqueous solvent content can be in an amount from about 25 wt % to about 44 wt %, about 25 wt % to about 43 wt %, about 25 wt % to about 42 wt %, about 25 wt % to about 42 wt %, about 25 wt % to about 41 wt %, about 25 wt % to about 40 wt %, about 25 wt % to about 39 wt %, about 25 wt % to about 38 wt %, about 25 wt % to about 37 wt %, about 25 wt % to about 36 wt %, about 25 wt % to about 35 wt %, about 25 wt % to about 34 wt %, about 25 wt % to about 33 wt %, about 25 wt % to about 32 wt %, about 25 wt % to about 31 wt %, about 25 wt % to about 30 wt %, about 25 wt % to about 29 wt %, about 25 wt % to about 28 wt %, about 25 wt % to about 27 wt %, about 25 wt % to about 26 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, or a range or value between any two preceeding values of the total weight of the detergent composition. In some aspects, the detergent composition comprises from about 25 wt % to about 45 wt % of a non-aqueous solvent comprising glycerin relative to the total weight of the detergent composition. In some aspects, the detergent composition comprises from about 25 wt % to about 40 wt % of glycerin.

In some aspects, the at least one surfactant is an anionic surfactant, a cationic surfactant, a zwitterionic surfactant, a nonionic surfactant, or a combination thereof. For example, the detergent composition can comprise an anionic surfactant, a nonionic surfactant, or a combination of one or more thereof. In some aspects, the detergent composition comprises a combination of at least one anionic surfactant and at least one nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl(dodecyl) sulfate, myristyl sulfate), dioctyl sodium sulfosuccinate, and an alkyl ether sulfate (also called an alcohol ethoxysulfate)). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), and a methyl ester sulfonate. Examples of a fatty acid salt include, e.g., a caprylate, a laurate, a palmitate, a myristate, and a stearate. Other anionic surfactants include a bile acid salt, a glutamic acid salt (e.g., N-myristoyl-1-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or any combination thereof.

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate.

In some aspects, the anionic surfactant comprises a linear alkylbenzene sulfonate (LAS). In some aspects, the LAS in the detergent composition is of Formula (I).

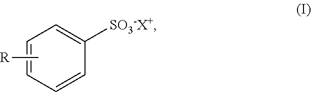

in which R is a linear C₁₀-C₁₈ (e.g., C₁₀, C₁₁, C₁₂, C₁₃, C₁₄, C₁₅, C₁₆, C₁₇, and C₁₈)alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the detergent composition does not comprise or is substantially free of a linear alkylbenzene sulfonate (LAS).

In some aspects, the anionic surfactant comprises an alkyl sulfate (e.g., a lauryl sulfate), a coco fatty acid, a linear alkylbenzene sulfonate, an alkyl ether sulfate, a methyl ester sulfonate, or a combination thereof. In some aspects, the anionic surfactant comprises a linear alkylbenzene sulfonate, an alcohol ethoxysulfate, a methyl ester sulfonate, or a combination thereof. In some aspects, the anionic surfactant comprises an alkyl ether sulfate (AES).

A cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof. Examples of the fatty amine salt include, e.g., a C₈-C₁₈ fatty amine salt (e.g., R⁵—NH₃⁺, in which R⁵ is a C₈-C₁₈ alkyl group). Examples of a fatty diamine salt include, e.g., R⁵—NH₂⁺—R⁶—NH₃⁺, in which R⁵ is a C₈-C₁₈ alkyl group and R⁶ is a C₁₋₆ alkyl. Examples of an alkoxylated amine and an alkoxylated diamine include a polyethoxylated fatty amine and diamine, respectively. Examples of a fatty quaternary ammonium compound include, e.g., R⁷—NR⁸₃⁺, in which R⁷ is a C₈-C₁₈ alkyl group and each R⁸ is a C₁₋₄ alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R⁹—C(O)N—R¹⁰—NR¹¹₃⁺, in which R⁹ is a C₇-C₁₇ alkyl group, R¹⁰ is a C₁₋₆ alkyl, and each R¹¹ is a C₁₋₄ alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g., benzalkonium chloride). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In any of the forgoing examples, the C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In some aspects, the cationic surfactant can be alkoxylated, in which polyalkylene glycol (e.g., polyethylene glycol, polypropylene glycol) repeat units can be disposed between the hydrophobic tail group (e.g., a fatty group) and hydrophilic head group.

The zwitterionic surfactant is amphoteric and comprises a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O—), a sulfate (—OSO₃⁻), sulfonate (—SO₃⁻), a phosphate (—OPO₃³⁻), a carboxylate (—C(O)O⁻), or the conjugate base of an organic acid.

In some aspects, the zwitterionic surfactant comprises a betaine, a sulfonated quaternary ammonium compound, a phosphinated quaternary ammonium compound, a trialkylamine N-oxide, or any combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio) butyrate, and lauryl-N,N-(dimethyl)-glycinebetaine. Examples of a sulfonated quaternary ammonium include, compound e.g., 3-(N,N-dimethyl-octylammonio) propanesulfonate, 4-(N,N-dimethyl-dodecylammonio) butanesulfonate, 3-{N,N-dimethyl-N-[3-(4-octylbenzoylamino) propyl]ammonio}propanesulfonate, 3-[(3-cholamidopropyl)dimethylammonio]-1-propanesulfonate, 3-([3-cholamidopropyl]dimethylammonio)-2-hydroxy-1-propanesulfonate, coco (amidopropyl)dimethylammonio-2-hydroxypropanesulfonate, lauryl-N,N-(dimethylammonio) butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio) propanesulfonate. Examples of a phosphinated quaternary ammonium compound include, e.g., a phosphocholine, such as N-dodecylphosphocholine and hexadecyl phosphocholine. Examples of a trialkylamine N-oxide include, e.g., R⁴—N(O—) R⁵₂⁺, in which R⁴ is a C₈-C₁₈ alkyl group, R⁵ is a C₁₄ alkyl, such as lauryldimethylamine N-oxide and 4-ethyl-N,N-2-trimethyloctan-1-amine oxide.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—) n; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate. Examples of a fatty acid alkoxylate include, e.g., R¹²—C(O)O-EO-H, in which R¹² is a C₇-C₁₇ alkyl group and EO is polyethoxylate. Examples of an alkyl phenol ethoxylate include, e.g., R¹²-phenyl-O (EO)—H, in which R¹² is a C₈-C₁₈ alkyl group and EO is polyethoxylate. Examples of an alkoxylated amine include, e.g., ethoxylated C₈-C₁₈ alkylamine, tallow amine ethoxylate, lauryl amine ethoxylate ether, 2-2-(2-hydroxyethoxy)ethylaminoethanol, bis(hydroxyethoxyethyl)amine, 2,2′-((2-(2-hydroxyethoxy)ethyl) azanediyl) diethanol, and coco bis(2-hydroxyethyl)amine. Example of an alkyl glucoside include, e.g., alkyl polyglucoside, such as C₈-C₁₈ polyglucoside which can include 1 to 3 glucoside units. Examples of a fatty amide alkoxylate include R¹³—C(O) NH-(EO)—H, in which R¹³ is a C₇-C₁₇ alkyl group and EO is polyethoxylate. Examples of a diester of alkoxylated fatty acid include, e.g., R¹⁴—C(O)O-EO—C(O)—R^{14′}, in which R¹⁴ and R^{14′} is a C₇-C₁₇ alkyl group and EO is polyethoxylate. Examples of an alkoxylated methyl ester of fatty acid (e.g., a methyl ester ethoxylate) include e.g., R¹⁵—C(O)O-EO-R¹⁶, in which R¹⁵ is a C₇-C₁₇ alkyl group, R¹⁶ is a C₁-C₄ alkyl group, and EO is polyethoxylate. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R¹⁷O-(EO)ₙ—(PO)ₘ-(EO)ₙ—R¹⁸, in which R¹⁷ and R¹⁸ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO-PPO-PEO and PPO-PEO-PPO. Examples of a phenol alkoxylate include, e.g., R⁵—C₆H₄-(EO)—H, wherein R⁵ is hydrogen or a C₁-C₁₈ alkyl group, and EO is polyethoxylate, such as octylphenol ethoxylate, nonylphenol ethoxylate, 2-phenoxydecan-1-ol, bisphenol ethoxylate, and a styrenated phenol ethoxylate (e.g., tristyrylphenol ethoxylate). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In any of the foregoing embodiments, the C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In general, the alcohol ethoxylate (AE) will have a chemical structure of formula

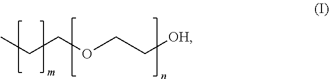

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol.

In some aspects, the detergent composition comprises an alcohol ethoxylate (AE), an alkyl ether sulfate (AES), a methyl ester ethoxylate, a coco fatty acid, an alkyl polyglucoside, or any combination thereof. In some aspects, the detergent composition comprises an alcohol ethoxylate (AE) and an alkyl ether sulfate (AES). In some of these aspects, the detergent composition comprises an alcohol ethoxylate (AE) and an alkyl ether sulfate (AES) and does not comprise (e.g., is substantially free of) a linear alkylbenzene sulfonate.

The detergent composition comprises from about 20 wt % to about 40 wt % of at least one surfactant (e.g., an alcohol ethoxylate (AE), an alkyl ether sulfate (AES), a methyl ester ethoxylate, a coco fatty acid, an alkyl polyglucoside, or any combination thereof) relative to the total weight of the detergent composition. For example, the total surfactant content can be from about 20 wt % to about 38 wt %, about 20 wt % to about 35 wt %, about 20 wt % to about 32 wt %, about 20 wt % to about 30 wt %, about 20 wt % to about 25 wt %, about 22 wt % to about 40 wt %, about 22 wt % to about 38 wt %, about 22 wt % to about 35 wt %, about 22 wt % to about 30 wt %, about 22 wt % to about 25 wt %, about 25 wt % to about 40 wt %, about 25 wt % to about 38 wt %, about 25 wt % to about 35 wt %, about 25 wt % to about 30 wt %, about 28 wt % to about 40 wt %, about 28 wt % to about 38 wt %, about 28 wt % to about 35 wt %, about 28 wt % to about 30 wt %, about 30 wt % to about 40 wt %, about 30 wt % to about 38 wt %, about 30 wt % to about 35 wt %, about 32 wt % to about 40 wt %, about 32 wt % to about 38 wt %, about 32 wt % to about 35 wt %, about 35 wt % to about 40 wt %, about 35 wt % to about 38 wt %, about 38 wt % to about 40 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, or about 20 wt % of the total weight of the detergent composition. In some aspects, the detergent composition comprises about 25 to about 38 wt % of at least one surfactant (e.g., a non-ionic alcohol ethoxylate (AE) and an alkyl ether sulfate (AES)).

The detergent composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, a mannanase, or a combination thereof.

In some aspects, the detergent composition comprises a total from about 0.01 wt % to about 5 wt % of at least one enzyme (e.g., a protease, an amylase, a mannanase, or a combination thereof) relative to the total weight of the detergent composition. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the detergent composition.

In some aspects, the detergent composition further comprises at least one additive. For example, the at least one (e.g., 1, 2, 3, 4, 5, or 6, etc.) additive can be selected from an acid, a base, an anti-redeposition agent, a performance polymer, a defoamer, a chelating agent, a chlorine scavenger, an optical brightener, a corrosion inhibitor, and any combination thereof.

In some aspects, the detergent composition comprises from about 1 wt % to about 20 wt % of a total amount of additives relative to the total weight of the detergent composition. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % of the total weight of the detergent composition.

To help maintain the pH, in some aspects, the detergent composition can further comprise an acid, which is any suitable compound with a pKa of less than about 10. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or a combination thereof. In some aspects, the detergent composition comprises citric acid. In some aspects, the acid can be an acid solution (e.g., an acid in water). In some aspects, the acid is a citric acid solution (e.g., a 50% citric acid solution).

In some aspects, the acid in the detergent composition is an organic acid, which in some instances can additionally act as a chelating agent. The organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, caprylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some aspects, the acid in the detergent composition is citric acid.

In some aspects, the detergent composition comprises from about 0.1 wt % to about 10 wt % of acid (e.g., an organic acid, such as citric acid) relative to the total weight of the detergent composition. For example, the acid can be present in an amount of about 0.1 wt % to about 5 wt %, about 0.1 wt % to about 3 wt %, about 0.1 wt % to about 2 wt %, about 0.1 wt % to about 1 wt %, about 0.1 wt % to about 0.8 wt %, about 0.1 wt % to about 0.6 wt %, about 0.1 wt % to about 0.4 wt %, about 0.1 wt % to about 0.3 wt %, about 0.2 wt % to about 10 wt %, about 0.2 wt % to about 5 wt %, about 0.2 wt % to about 3 wt %, about 0.2 wt % to about 2 wt %, about 0.2 wt % to about 1 wt %, about 0.2 wt % to about 0.8 wt %, about 0.2 wt % to about 0.6 wt %, about 0.2 wt % to about 0.4 wt %, about 0.2 wt % to about 0.3 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1 wt %, about 0.5 wt % to about 0.8 wt %, about 0.5 wt % to about 0.6 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.15 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 0.1 wt % to about 1 wt % or about 0.2 wt % to about 0.5 wt % of an organic acid (e.g., citric acid).

In some aspects, the detergent composition comprises a base to adjust the pH. The base can be any suitable compound with a pKb of about 0.1 to about 13. In some aspects, the base can be monoethanolamine, diethanolamine, triethanolamine, methyl diethanolamine, a hydroxide, a tetraborate, a phosphate, a carbonate, a bicarbonate, or any combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the base can be a base solution (e.g., a base in water). In some aspects, the detergent composition comprises monoethanolamine. In some aspects, the base in the detergent composition is sodium hydroxide. In some aspects, the base is a base solution (e.g., a 50% sodium hydroxide solution).

In some aspects, the detergent composition comprises from about 0.1 wt % to about 15 wt % of base (e.g., a Group I hydroxide, sodium carbonate, monoethanolamine) relative to the total weight of the detergent composition. For example, the base can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the detergent composition. In some aspects, the detergent composition comprises from about 0.1 wt % to about 5 wt %, from about 0.1 wt % to about 3 wt %, or from about 0.1 wt % to about 2 wt % of base. In some aspects, the detergent composition comprises not more than 2 wt % monoethanolamine. In some aspects, the detergent composition comprises not more than 2 wt % sodium hydroxide (e.g., a 50% NaOH solution).

In some aspects, the detergent composition comprises an acid and a base to form a buffer. The buffer can be any suitable composition that is water soluble and controls (i.e., maintains) the pH of the detergent composition within a pH of about 5 to about 7.7 (e.g., maintains a pH of about 5, about 5.5, about 6, about 6.5, about 7, about 7.5, or about 7.7). In some embodiments, the pH can be controlled to be within a range of about 6 to about 7.1 or a pH of about 7. In general, the buffer can comprise a weak acid and its conjugate base, a strong acid and a weak base, or a strong base and a weak acid. Examples of suitable acids and bases are described herein. In general, a strong acid will have a pKa of less than 2 and a weak acid will have a pKa of 2 or greater. In general, a strong base will have a pKb of less than 2 and a weak base will have a pKb of 2 or greater. For example, the buffer can comprise sodium hydroxide in combination with a weak acid, such as citric acid.

The buffer typically is an aqueous buffer but other non-aqueous solvents can be present, such as an alcohol (e.g., ethanol). In some aspects, the buffer comprises water as the only solvent. In other embodiment, the buffer can comprise water and at least one (e.g., 1, 2, or 3) non-aqueous solvent in any suitable ratio, such as a non-aqueous solvent to water volume ratio ranging from 99.9:0.1 to 0.1:99.9. In some aspects, the non-aqueous solvent to water volume ratio is about 1:99, about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, etc.). In a specific example, ethanol (EtOH) and water are used in a volume ratio ranging from 50:50 to 90:10 EtOH:H₂O (e.g., about 70:30, about 75:25, about 80:20, about 85:15, or about 90:10, etc.).

In some aspects, the detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the detergent composition comprises from about 0.001 wt % to about 5 wt % of an anti-redeposition agent relative to the total weight of the detergent composition. For example, the anti-redeposition agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the detergent composition comprises a performance polymer that improves at least one aspect of a washed textile. In some aspects, the performance polymer improves the cleaning action of the detergent composition, removes or reduces stains, maintains whiteness, protects color, protects the integrity of a textile, provides odor control, or any combination thereof. In some aspects the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acylamino tertiary butyl sulfonate, or any combination thereof. In some aspects the performance polymer comprises an alkoxylated polyethyleneimine, such as polyethyleneimine ethoxylate, polyethyleneimine ethoxylate propoxylate, or a combination of both.

In some aspects, the detergent composition comprises from about 1 wt % to about 10 wt % of a performance polymer relative to the total weight of the detergent composition. For example, the performance polymer can be from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 5 wt % to about 10 wt % of a performance polymer (e.g., an alkoxylated polyethyleneimine).

In some aspects, the detergent composition comprises a defoamer that helps maintain the rise of foam, which can, in some aspects, avoid high foaming or water spilling from a washing machine. In general, the defoamer has a low viscosity. In some aspects the defoamer comprises coconut fatty acid, a silicone, ethylene-bis-stearamide, a fatty acid, a fatty alcohol, or any combination thereof. In an aspect, the defoamer is coconut fatty acid.

In some aspects, the detergent composition comprises from about 0.1 wt % to about 10 wt % of a defoamer relative to the total weight of the detergent composition. For example, the defoamer can be from about 0.1 wt % to about 8 wt %, about 0.1 wt % to about 5 wt %, about 0.1 wt % to about 3 wt %, about 0.5 wt % to about 10 wt %, about 0.5 wt % to about 8 wt %, about 0.5 wt % to about 5 wt %, about 0.5 wt % to about 3 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 1 wt % to about 5 wt % or about 1 wt % to about 3 wt % of a defoamer (e.g., coconut fatty acid) relative to the total weight of the detergent composition.

In some aspects, the detergent composition comprises a chelating agent (i.e., a chelant) that serves to improve the cleaning action of the detergent by scavenging metal ions naturally found in water. Suitable examples of a chelating agent includes, e.g., citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate), or any combination thereof. In some aspects, the liquid composition comprises iminodisuccinic acid and/or tetrasodium iminodisuccinate.

In some aspects, the detergent composition comprises from about 0.001 wt % to about 5 wt % of a chelating agent relative to the total weight of the detergent composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 1 wt % to about 5 wt % or about 1 wt % to about 3 wt % of a chelating agent (e.g., iminodisuccinic acid and/or a salt thereof).

In some aspects, the detergent composition comprises a chlorine scavenger. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor. Examples of a chlorine scavenger include, e.g., an amino acid, iminodisuccinic acid, potassium nitrate, sodium nitrate, iminodisuccinic acid or a salt thereof (e.g., tetrasodium iminodisuccinate), tris(hydroxymethyl) aminomethane, 2-amino-2-methyl-1,3-propanediol, 2-amino-2-ethyl-1,3-propanediol, 2-amino-1-butanol, 1-amino-2-propanol, 2-amino-1-propanol, 2-amino-2-methyl-1-propanol, monoethanolamine, diethanolamine, tris(hydroxymethyl)aminomethane, hexamethylenetetramine, and any combination thereof. In some aspects, the chlorine scavenger can be monoethanolamine or iminodisuccinic acid.

In some aspects, the chlorine scavenger comprises at least one amino acid. In general, the amino acid is a naturally occurring amino acid, including one of the 20 naturally occurring amino acids (e.g., alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, or any combination thereof). In some aspects, the amino acid has a charged side chain (e.g., arginine, aspartic acid, glutamic acid, histidine, or lysine). In some aspects, the at least one amino acid has a polar uncharged side chain (e.g., serine, threonine, asparagine, or glutamine). In the aspects, the at least one amino acid has a hydrophobic side chain (e.g., alanine, valine, isoleucine, leucine, methionine, phenylalanine, tyrosine, or tryptophan). In some aspects, the at least one amino acid is cysteine, glycine, or proline. In some aspects, the at least one amino acid has a charged side chain or a polar uncharged side chain. In some aspects, the at least one amino acid is in the form of a salt, e.g., lysine hydrochloride.

In some aspects, the detergent composition comprises from about 0.001 wt % to about 5 wt % of a chlorine scavenger relative to the total weight of the detergent composition. For example, the chlorine scavenger can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 3 wt %, about 1 wt % to about 2 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the detergent composition comprises an optical brightener (e.g., a fluorescent whitening agent), which is any suitable hydrophilic compound that absorbs ultra violet light and emits visible (e.g., blue-violet) light to make textiles appear brighter. The optical brightener can comprise a triazole, a stilbene, or a biphenyl group. Examples of the optical brightener include, e.g., 2,2′-(2,5-thienediyl)bis[5-(2-methyl-2-propanyl)-1,3-benzoxazole, 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 2′,7′-bis(5-(4-(tert-butyl)phenyl)-1,3,4-oxadiazol-2-yl)-N³,N³,N⁶,N⁶-tetraphenyl-9,9′-spirobi[fluorene]-3,6-diamine, N,N-diphenyl-4-(5-(4-(triphenylsilyl)phenyl)-1,3,4-oxadiazol-2-yl) aniline, ((4-((4-(5-(4-nitrophenyl)-1,3,4-oxadiazol-2-yl)phenyl)diazenyl)phenyl) azanediyl)bis(ethane-2,1-diyl)diacetate, ((4-((4-(5-(4-((E)-4-nitrostyryl)phenyl)-1,3,4-oxadiazol-2-yl)phenyl)diazenyl)phenyl) azanediyl)bis(ethane-2,1-diyl)diacetate, 4,4′-diamino-2,2′-stilbenedisulfonic acid, 4,4′-bis(benzoxazolyl)-cis-stilbene, and 2,5-bis(benzoxazol-2-yl)thiophene, and any combination thereof. In some aspects, the optical brightener can be 2,2′-(2,5-thienediyl)bis[5-(2-methyl-2-propanyl)-1,3-benzoxazole.

In some aspects, the detergent composition can comprise from about 0.001 wt % to about 5 wt % of an optical brightener relative to the total weight of the detergent composition. For example, the optical brightener can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the detergent composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting. Examples of the corrosion inhibitor include, e.g., an inorganic corrosion inhibitor (e.g., a sulfite, a silicate, a polyphosphate, calcium hydroxide), an organic corrosion inhibitor (e.g., calcium hydrogen carbonate, a sulfonate, a phosphonate, a C₁₂-C₁₅ alcohol ether phosphate), or a combination thereof. In an aspect, the corrosion inhibitor can be sodium sulfite.

In some aspects, the detergent composition comprises from about 0.001 wt % to about 5 wt % of a corrosion inhibitor (e.g., an oxygen scavenger) relative to the total weight of the detergent composition. For example, the corrosion inhibitor can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the detergent composition comprises an acid, a base, at least one performance polymer, a defoamer, and a chelating agent as additives. In some aspects, the detergent composition comprises sodium hydroxide, citric acid, coconut fatty acid, an alkoxylated polyethyleneimine, and iminodisuccinic acid as additives. In some aspects, the detergent composition comprises an acid, a base, a defoamer, and a chelating agent as additives. In some aspects, the detergent composition comprises sodium hydroxide, citric acid, coconut fatty acid, and iminodisuccinic acid as additives.

In some aspects, the detergent composition consists essentially of about 20 to about 35 wt % water, about 20 to about 40 wt % of at least one surfactant, about 25 to about 45 wt % of a non-aqueous solvent comprising glycerin, at least one enzyme; and optionally at least one additive, wherein the water activity is less than 0.8, and the detergent composition has a pH of about 5 to about 7.7.

In some aspects, the detergent composition consists of about 20 to about 35 wt % water, about 20 to about 40 wt % of at least one surfactant, about 25 to about 45 wt % of a non-aqueous solvent comprising glycerin, at least one enzyme, and at least one additive; wherein the water activity is less than 0.8, and the detergent composition has a pH of about 5 to about 7.7.

In some aspects, the detergent composition comprises about 20 to about 35 wt % water, about 25 to about 38 wt % of surfactant comprising a non-ionic alcohol ethoxylate (AE) and an alkyl ether sulfate (AES), about 25 to about 40 wt % of glycerin, about 1 to about 3 wt % of at least one enzyme, an acid, a base, at least one performance polymer, a defoamer, and a chelating agent; wherein the water activity is less than 0.75, and the detergent composition has a pH of about 6 to about 7.

In some aspects, the detergent composition consists essentially of about 20 to about 35 wt % water, about 25 to about 38 wt % of surfactant comprising a non-ionic alcohol ethoxylate (AE) and an alkyl ether sulfate (AES), about 25 to about 40 wt % of glycerin, about 1 to about 3 wt % of at least one enzyme, an acid, a base, at least one performance polymer, a defoamer, and a chelating agent; wherein the water activity is less than 0.75, and the detergent composition has a pH of about 6 to about 7.

In some aspects, the detergent composition consists of about 20 to about 35 wt % water, about 25 to about 38 wt % of surfactant comprising a non-ionic alcohol ethoxylate (AE) and an alkyl ether sulfate (AES), about 25 to about 40 wt % of glycerin, about 1 to about 3 wt % of at least one enzyme, and an acid, a base, at least one performance polymer, a defoamer, and a chelating agent; wherein the water activity is less than 0.75, and the detergent composition has a pH of about 6 to about 7.

In some aspects, the detergent composition is about two to four times (e.g., about 2×, about 2.5×, about 3×, about 3.5×, or about 4×) more concentrated than a standard detergent dose, which is typically about 1.5 fluid ounces per dose. In some aspects, the detergent composition is about 0.4 to about 0.8 fluid ounces (i.e., about 11.8 to about 23.7 ml) per dose. For example, the detergent composition can be about 0.5 to about 0.8 fluid ounces per dose, about 0.6 to about 0.8 fluid ounces per dose, about 0.7 to about 0.8 fluid ounces per dose, about 0.4 to about 0.7 fluid ounces per dose, about 0.4 to about 0.6 fluid ounces per dose, about 0.4 to about 0.5 fluid ounces per dose, about 0.4 fluid ounces per dose, about 0.45 fluid ounces per dose, about 0.5 fluid ounces per dose, about 0.55 fluid ounces per dose, about 0.6 fluid ounces per dose, about 0.65 fluid ounces per dose, about 0.7 fluid ounces per dose, about 0.75 fluid ounces per dose, or about 0.8 fluid ounces per dose, or any range or value between any two preceeding values fluid ounces per dose. In some aspects, the detergent composition is about 0.5 fluid ounces (i.e., about 14.8 ml) per dose. In some aspects, the detergent composition is about 0.6 fluid ounces (i.e., about 17.7 ml) per dose. In some aspects, the detergent composition is about 0.75 fluid ounces (i.e., about 22.2 ml) per dose.

In some aspects, the detergent composition is a liquid, including a liquid that is dispensed from a container upon use.

In some aspects, the present disclosure is directed to a method of using the unit dose product of any of the foregoing aspects. For example, the unit dose product can be used in a method of removing soil from a textile (e.g., cleaning a textile, such as a fabric). In particular, the present disclosure is directed to a method of removing soil from a textile comprising contacting the textile with a composition comprising the unit dose product described herein and water to form a washing load. Optional steps include mixing (e.g., agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and combinations thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 10-20° C., about 12-16° C., or about 15° C.).

In an aspect, the method is directed to providing a mild detergent composition.

In an aspect, the method is directed to providing an allergen-free detergent composition.

In an aspect, the method is directed to providing detergent compositions comprising Safer Choice ingredients.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Exemplary detergent compositions were prepared with the components listed in Table 1.

TABLE 1

| | Formula 1 | Formula 2 | Formula 3 | Formula 4 | Formula 5 | Formula 6 |
|---|---|---|---|---|---|---|
| Dose (g) | 23.51 | 18.8 | 15.6 | 23.51 | 18.8 | 15.6 |
| Dose (fluid oz) | 0.75 | 0.6 | 0.5 | 0.75 | 0.6 | 0.5 |
| Water Activity | — | 0.74 | 0.74 | — | 0.74 | — |
| Density | — | 1.11 | — | — | 1.1 | — |
| (approximate, g/mL) | | | | | | |
| Viscosity | — | 350 | — | — | 350 | — |
| (approximate, cP) | | | | | | |
| pH | | 7 | | | 7 | |
| Concentration | 2x | 2.5x | 3x | 2x OXI | 2.5x OXI | 3x OXI |
| COMPONENT | wt % in Formula | | | | | |
| Glycerin | 38.85 | 35.56 | 31.58 | 35.62 | 31.71 | 26.94 |
| Fatty alcohol ethoxylate | 21.07 | 25 | 30.12 | 21.07 | 25 | 30.12 |
| (25-7) | | | | | | |
| Sodium Hydroxide 50% | 0.17 | 0.2 | 0.24 | 0.17 | 0.2 | 0.24 |
| Citric Acid | 1.2 | 1.5 | 1.8 | 1.2 | 1.5 | 1.8 |
| (50% Solution) and | | | | | | |
| Coconut Fatty Acid | | | | | | |
| Water | 31.79 | 29.09 | 25.84 | 29.14 | 25.94 | 22.04 |
| 50/50 Blend of | 0 | 0 | 0 | 5.88 | 7 | 8.43 |
| polyethyleneimine | | | | | | |
| ethoxylate and | | | | | | |
| polyethyleneimine | | | | | | |
| ethoxylate propoxylate | | | | | | |
| Alkyl ether sulfate, 3EO, | 4 | 5 | 6.02 | 4 | 5 | 6.02 |
| 70% paste | | | | | | |
| Protease, Amylase, | 2.92 | 3.65 | 4.4 | 2.92 | 3.65 | 4.4 |
| Mannanase, and | | | | | | |
| Iminodisuccinic Acid | | | | | | |
| (34% Active) | | | | | | |
| Total | 100 | 100 | 100 | 100 | 100 | 100 |

The target pH of the compositions was about 6 to about 7.

Additional solvents, such as ethanol and/or a glycol ether, can be added to lower the viscosity, if needed. If additional chlorine scavenging is needed, a higher level of iminodisuccinic acid can be used or a chlorine scavenger, such as an amino acid, can be added to the detergent composition.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A detergent composition comprising
i. about 20 to about 35 weight percent (wt %) water,
ii. about 20 to about 40 wt % of at least one surfactant,
iii. about 25 to about 45 wt % of a non-aqueous solvent comprising glycerin, and
iv. at least one enzyme;
wherein the water activity is less than 0.8, and
the composition has a pH of about 5 to about 7.7.

2. The detergent composition of claim 1, wherein the water activity is between 0.65 to about 0.75.

3. The detergent composition of claim 1, wherein the detergent composition does not comprise a preservative.

4. The detergent composition of claim 1, wherein the detergent composition has Zein score of not more than about 2% or not more than about 1% dissolved zein when tested on a 3% dilution.

5. The detergent composition of claim 1, wherein the detergent composition comprises about 25 to about 40 wt % of glycerin.

6. The detergent composition of claim 1, wherein the detergent composition does not comprise propylene glycol.

7. The detergent composition of claim 1, wherein the detergent composition does not comprise polyethylene glycol (PEG).

8. The detergent composition of claim 1, wherein the at least one surfactant comprises a non-ionic alcohol ethoxylate (AE), an alkyl ether sulfate (AES), or a combination of both.

9. The detergent composition of claim 8, wherein the non-ionic alcohol ethoxylate (AE) comprises the formula R¹-(EO)ₙ—OH, wherein R¹ is a C₁₂-C₁₈ alkyl group, EO is ethoxylate, and n is an integer of moles from 1 to 15.

10. The detergent composition of claim 1, wherein the detergent composition does not comprise a linear alkylbenzene sulfonate.

11. The detergent composition of claim 1, wherein the detergent composition further comprises at least one additive selected from an acid, a base, an anti-redeposition agent, a performance polymer, a defoamer, a chelating agent, a chlorine scavenger, an optical brightener, a corrosion inhibitor, and a combination thereof.

12. The detergent composition of claim 1, wherein the at least one enzyme is selected from a protease, an amylase, a mannanase, a lactase, a lipase, a perhydrolase, an oxidoreductase, an endocellulase, an exocellulase, and any combination thereof.

13. The detergent composition of claim 12, wherein the enzyme is selected from an amylase, a protease, a mannanase, and any combination thereof.

14. The detergent composition of claim 12, wherein the detergent composition comprises about 0.1 to about 5 wt % enzyme.

15. The detergent composition of claim 11, wherein the detergent composition comprises an acid and a base to form a buffer.

16. The detergent composition of claim 15, wherein the acid is citric acid and the base is NaOH.

17. The detergent composition of claim 1, wherein the detergent composition has a pH of about 6 to about 7.

18. The detergent composition of claim 11, wherein the performance polymer comprises at least one of polyethyleneimine ethoxylate and polyethyleneimine ethoxylate propoxylate.

19. The detergent composition of claim 1, wherein the detergent composition is about 0.4 to about 0.8 fluid ounces per dose.

20. The detergent composition of claim 1, comprising about 25 to about 38 wt % of surfactant comprising a non-ionic alcohol ethoxylate (AE) and an alkyl ether sulfate (AES),
about 25 to about 40 wt % of glycerin,
about 1 to about 3 wt % of at least one enzyme, and
an acid, a base, at least one performance polymer, a defoamer, and a chelating agent;
wherein the water activity is less than 0.75, and
the detergent composition has a pH of about 6 to about 7.
